(19) United States
(12) Patent Application Publication
(10) Pub. No.: US 2025/0215671 A1
(43) Pub. Date: Jul. 3, 2025

(54) POTABLE WATER EXTRACTING AND DISPENSING APPARATUS

(71) Applicants: Hudson Kuykendall, Sikeston, MO (US); Danny Kuykendall, Sikeston, MO (US)

(72) Inventors: Hudson Kuykendall, Sikeston, MO (US); Danny Kuykendall, Sikeston, MO (US)

(21) Appl. No.: 18/399,203

(22) Filed: Dec. 28, 2023

(51) Int. Cl. E03B 3/28; B01D 53/26

(52) U.S. Cl. CPC E03B 3/28; B01D 53/265; B01D 2257/80; B01D 2258/06

(57) ABSTRACT

A potable water extracting and dispensing apparatus for extracting potable water from the air includes a housing that has a channel extending therethrough. A blower is mounted in the channel and blows air through the channel. A cooling assembly is mounted in the channel and cools a cooling member of the cooling assembly such that moisture from the air flowing through the chamber condenses onto the cooling member. The condensate formed by the moisture is collected in a reservoir which may be dispensed through a filter and out a dispensing tube extending outwardly of the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to potable water extracting apparatus and more particularly pertains to a new potable water extracting apparatus for extracting potable water from the air.

### (2) Description of Related Art Including Information Disclosed Under 37 CFR 1.97 and 1.98

The prior art discloses myriad potable water extracting apparatuses, including apparatuses powered by solar panels, mounted on trailers, and using vapor-compression refrigeration assemblies. However. The prior art fails to describe such an apparatus which provides a pump to add water from an external source to the reservoir that stores condensate extracted from the air. The prior art also does not disclose such an apparatus with a combination of a power inlet for electrically charging a battery through external means separate from the solar panels, a power outlet for powering external electronics via the battery, and a display for monitoring data related to the apparatus including power level of the battery and water level in the reservoir.

### BRIEF SUMMARY OF THE INVENTION

An embodiment of the disclosure meets the needs presented above by generally comprising a housing has a channel extending therethrough and has an inlet end and an outlet end. A cooling assembly is mounted in the housing and has a cooling member positioned in the channel. The cooling assembly is configured for cooling the cooling member to cause a moisture from an air to form condensate on the cooling member. A blower is mounted in the housing and positioned in the channel. The blower is configured for drawing the air into the channel through the inlet end and urging the air out of the channel through the outlet end. A reservoir is mounted in the housing which has an opening extending into the reservoir and is in fluid communication with the channel. The opening is positioned in relation to the evaporator such that the opening is configured for receiving the condensate from the evaporator. A filter is in fluid communication with the reservoir and is configured to filter foreign matter from the condensate. A dispensing tube is in fluid communication with the filter and extending out of the housing to an open end of the dispensing tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a potable water extracting and dispensing apparatus according to an embodiment of the disclosure.

FIG. 2 is a front view of an embodiment of the disclosure.

FIG. 3 is a side view of an embodiment of the disclosure.

FIG. 4 is a cross-section view of an embodiment of the disclosure taken from Arrows 4-4 in FIG. 2.

FIG. 5 is a rear view of an embodiment of the disclosure.

FIG. 6 is a perspective in-use view of an embodiment of the disclosure.

### DETAILED DESCRIPTION OF THE INVENTION

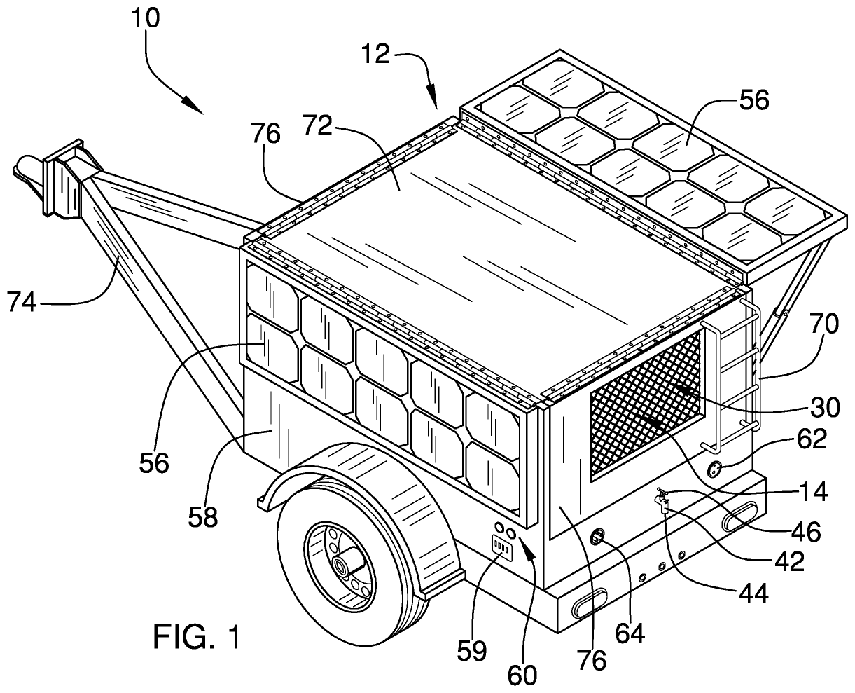

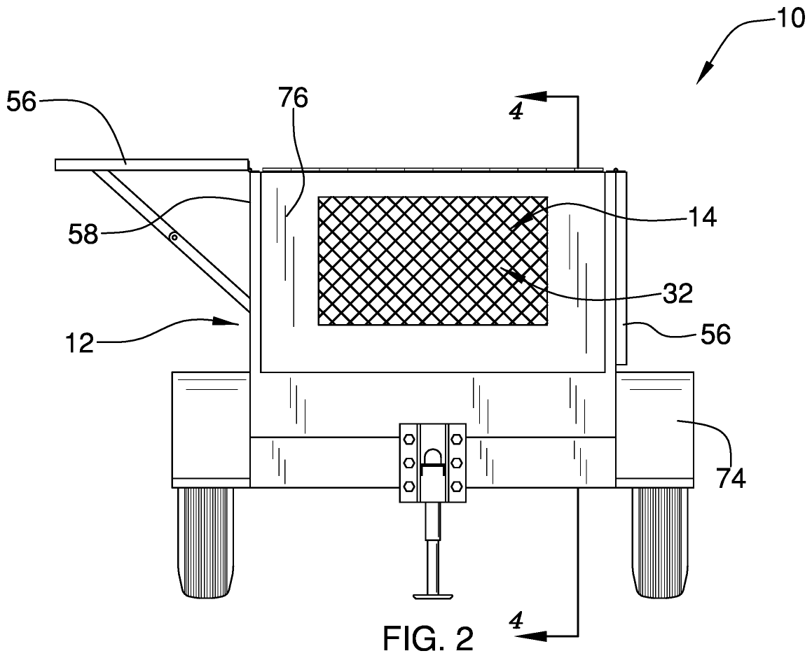

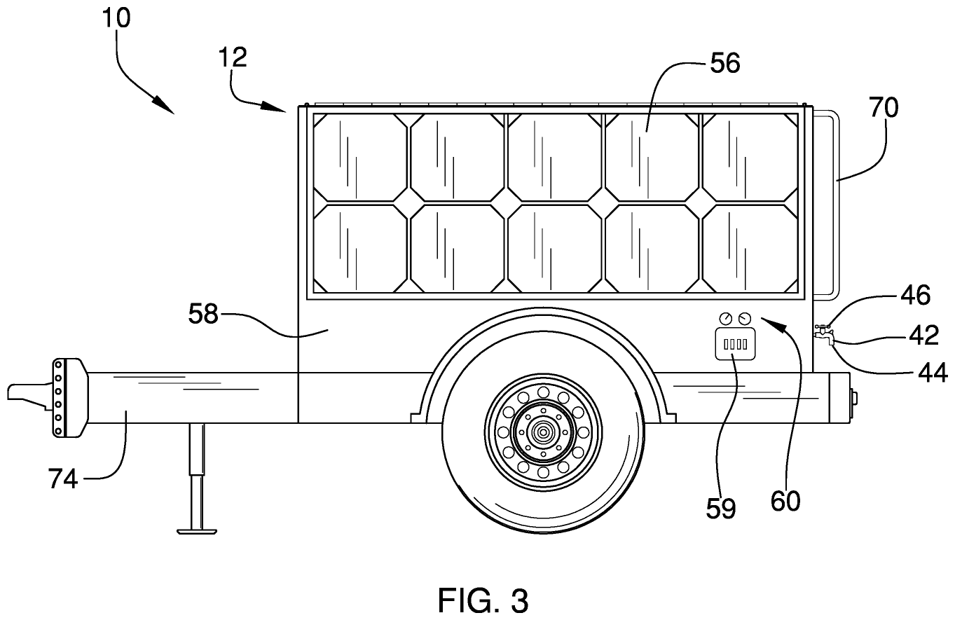

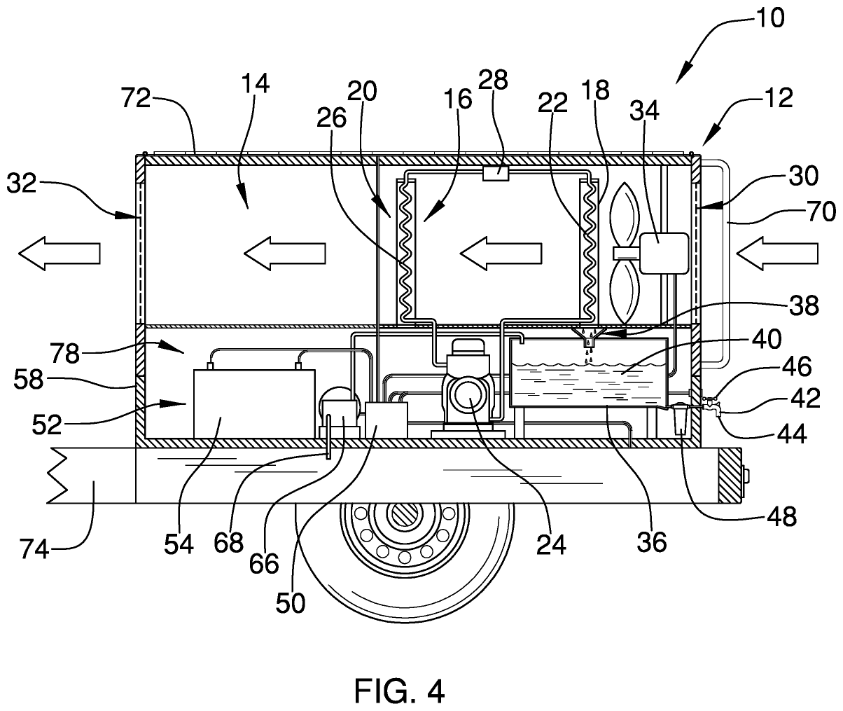

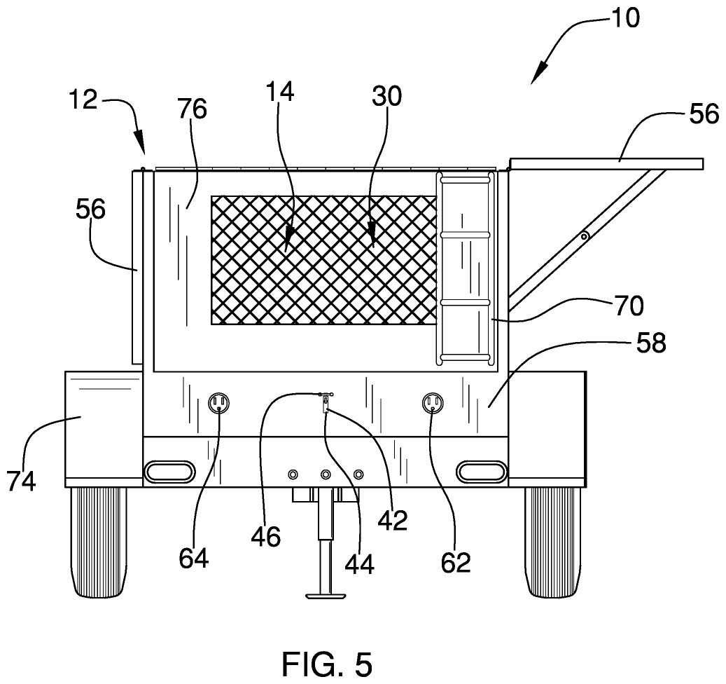

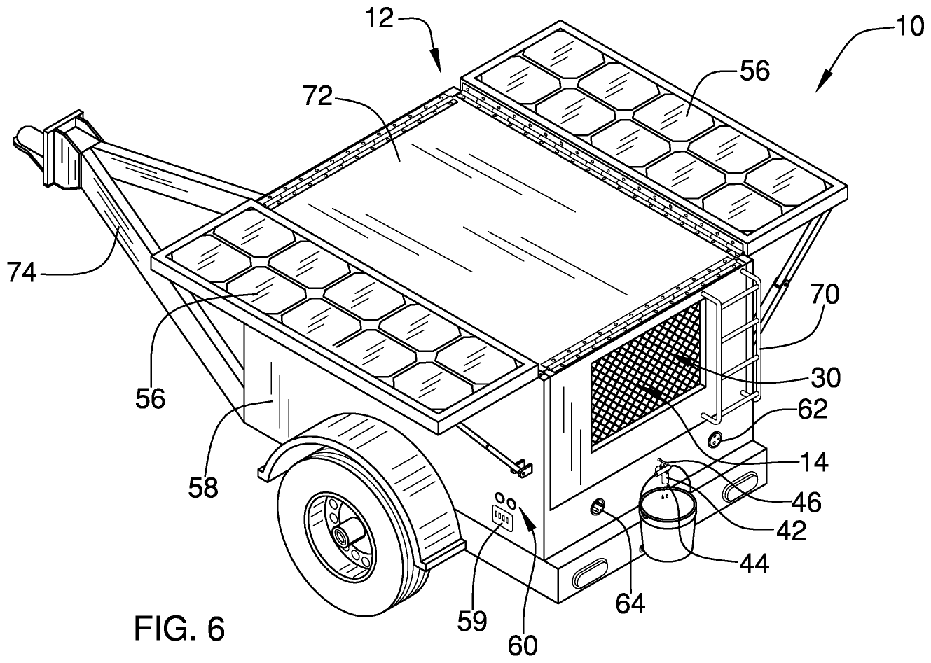

With reference now to the drawings, and in particular to FIGS. 1 through 6 thereof, a new potable water extracting apparatus embodying the principles and concepts of an embodiment of the disclosure and generally designated by the reference numeral 10 will be described.

As best illustrated in FIGS. 1 through 6, the potable water extracting and dispensing apparatus 10 generally comprises a housing 12 having a channel 14 extending therethrough and having an inlet end 30 and an outlet 32. A cooling assembly 16 is mounted in the housing 12 and has a cooling member 18 positioned in the channel 14. The cooling assembly 16 is configured for cooling the cooling member 18 to cause moisture from a quantity of air to form condensate 40 on the cooling member 18. The cooling assembly 16 is a vapor-compression refrigeration assembly 20 wherein the cooling member 18 is an evaporator 22. The vapor-compression refrigeration assembly 20 further comprises a compressor 24, a condenser 26, an expansion valve 46, and a refrigerant. The vapor-compression refrigeration assembly 20 is arranged such that the compressor 24 is operable to urge the refrigerant consecutively and cyclically through each of the condenser 26, the expansion valve 46, and the evaporator 22. The condenser 26 is positioned in the channel 14 and between the evaporator 22 and the outlet 32 of the channel 14 along a flow path extends through the channel 14 from the inlet end 30 of the channel 14 to the outlet 32 of the channel 14.

A blower 34 is mounted in the housing 12 and positioned in the channel 14. The blower 34 is configured for drawing the air into the channel 14 through the inlet end 30 and urging the air out of the channel 14 through the outlet 32. A reservoir 36 is mounted in the housing 12 and has an opening 38 extending into the reservoir 36 which is in fluid communication with the channel 14. The opening 38 is positioned in relation to the evaporator 22 such that the opening 38 is configured for receiving the condensate 40 from the evaporator 22. A portion of the reservoir 36 which extends around the opening 38 has a funnel shape to direct the condensate 40 through the opening 38 into the reservoir 36.

A filter 48 is in fluid communication with the reservoir 36 and is configured to filter foreign matter from the condensate 40. The filter 48 comprises conventional filtering means and may include a porous barrier, an ion exchange filter, a reverse osmosis filter, an activated carbon filter, or the like. A dispensing tube 42 is in fluid communication with the filter 48 and extends out of the housing 12 to an open end 44 of the dispensing tube 42. A valve 46 is coupled to the dispensing tube 42 and is movable between open and closed positions. The valve 46 is configured to permit condensate 40 through the dispensing tube 42 only when the valve 46 is open.

A control circuit 50 is operatively coupled to the cooling assembly 16 and the blower 34. A power supply 52 is electrically coupled to the control circuit 50 and comprises a battery 54. A pair of solar panels 56 is mounted on an exterior 58 of the housing 12 and is electrically coupled to the battery 54. Each solar panel 56 of the pair of solar panels 56 is mounted to an associated one of a pair of lateral sides of the housing 12 and is pivotably coupled to an upper edge of the associated lateral side. Each solar panel 56 of the pair of solar panels 56 is pivotable between a lowered position and a raised position, wherein each solar panel 56 of the pair of solar panels 56 faces away from the associated lateral side when positioned in the lowered position and facing upwardly when positioned in the raised position.

An input 59 is in communication with the control circuit 50 for controlling the control circuit 50 and is mounted on the exterior 58 of the housing 12. Sensors may be provided to obtain data concerning the potable water extracting and dispensing apparatus 10. For example, the sensors may be configured to detect a power level of the battery 54 and a water level within the reservoir 36. The data collected by the sensors may be presented on a display 60 mounted on the exterior 58 of the housing 12. The display 60 may include gauges or other indicators which are configured to present the data collected by the sensors. The control circuit 50 may also be in communication with the sensors and the display 60 and be configured to cause the display 60 to present the data collected by the sensors. A power outlet 62 is electrically coupled to the power supply 52 and is positioned on the exterior 58 of the housing 12 so that external electronics may be powered by the power supply 52. A power inlet 64 is electrically coupled to the power supply 52 and is positioned on the exterior 58 of the housing 12 so that the battery 54 may be charged by an exterior power source.

A pump 66 is mounted in the housing 12 and is in fluid communication with the reservoir 36. The pump 66 is arranged such that the pump 66 is configured for urging water toward the reservoir 36 from outside of the housing 12. An intake pip 68 is coupled to the pump 66 and extends outwardly of the housing 12. A ladder 70 is coupled to the exterior 58 of the housing 12 for facilitating access to a top 72 of the housing 12. The housing 12 is supported on a trailer 74 to facilitate transportation of the housing 12 via an automobile. Access panels 76 are also pivotably mounted to the housing 12 to facilitate accessing an interior 78 of the housing 12 including the channel 14.

In use, the blower 34 is activated to cause air to flow along the flow path through the channel 14, and the cooling assembly 16 is activated to cause condensate 40 to form on the cooling member 18. The condensate 40 is collected in the reservoir 36 and may be dispensed through the filter 48 and the dispensing tube 42 by opening 38 the valve 46. Water may also be added to the reservoir 36 by urging it from the intake pip 68 with the pump 66. A hose may be attached to the intake pip 68 to facilitate adding water from a remote source of water. The solar panels 56 are deployable to charge the battery 54, and the battery 54 is chargeable via the power inlet 64. Power may be drawn from the battery 54 using the power outlet 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A potable water extracting and dispensing apparatus comprising:
a housing having a channel extending therethrough and having an inlet end and an outlet end;
a cooling assembly being mounted in the housing and having a cooling member positioned in the channel, the cooling assembly being configured for cooling the cooling member to cause a moisture from an air to form condensate on the cooling member;
a blower being mounted in the housing and positioned in the channel, the blower being configured for drawing the air into the channel through the inlet end and urging the air out of the channel through the outlet end;
a reservoir being mounted in the housing, the reservoir having an opening extending into the reservoir and being in fluid communication with the channel, the opening being positioned in relation to the evaporator such that the opening is configured for receiving the condensate from the evaporator;
a filter being in fluid communication with the reservoir, the filter being configured to filter foreign matter from the condensate; and
a dispensing tube being in fluid communication with the filter and extending out of the housing to an open end of the dispensing tube.

2. The apparatus of claim 1, wherein the cooling assembly is a vapor-compression refrigeration assembly and the cooling member of the cooling assembly is an evaporator, the vapor-compression refrigeration assembly further comprising a compressor, a condenser, an expansion valve, and a refrigerant, the vapor-compression refrigeration assembly being arranged such that the compressor is operable to urge the refrigerant consecutively and cyclically through each of the condenser, the expansion valve, and the evaporator.

3. The apparatus of claim 2, wherein the condenser is positioned in the channel and between the evaporator and the outlet end of the channel along a flow path extending through the channel from the inlet end of the channel to the outlet end of the channel.

4. The apparatus of claim 1, further comprising a valve being coupled to the dispensing tube and being movable between open and closed positions, the valve being configured to permit condensate through the dispensing tube only when the valve is open.

5. The apparatus of claim 1, further comprising:
a control circuit being operatively coupled to the cooling assembly and the blower;
a power supply being electrically coupled to the control circuit.

6. The apparatus of claim 5, wherein the power supply comprises a battery.

7. The apparatus of claim 6, further comprising at least one solar panel being mounted on an exterior of the housing and being electrically coupled to the battery.

8. The apparatus of claim 7, wherein the at least one solar panel includes a pair of solar panels, each solar panel of the pair of solar panels being mounted to an associated one of a pair of lateral sides of the housing.

9. The apparatus of claim 8, wherein each solar panel of the pair of solar panels is pivotably coupled to an upper edge of the associated lateral side, each solar panel of the pair of solar panels being pivotable between a lowered position and a raised position, each solar panel of the pair of solar panels facing away from the associated lateral side when positioned in the lowered position and facing upwardly when positioned in the raised position.

10. The apparatus of claim 5, further comprising an input being in communication with the control circuit for controlling the control circuit.

11. The apparatus of claim 10, wherein the input is mounted on the exterior of the housing.

12. The apparatus of claim 5, further comprising a power outlet being electrically coupled to the power supply and being positioned on the exterior of the housing.

13. The apparatus of claim 5, further comprising a power inlet being electrically coupled to the power supply and being positioned on the exterior of the housing.

14. The apparatus of claim 1, further comprising a pump being mounted in the housing and being in fluid communication with the reservoir, the pump being arranged such that the pump is configured for urging water toward the reservoir from outside of the housing.

15. The apparatus of claim 14, further comprising an intake pipe being coupled to the pump and extending outwardly of the housing.

16. The apparatus of claim 1, further comprising a ladder being coupled to the exterior of the housing for facilitating access to a top of the housing.

17. The apparatus of claim 1, further comprising a trailer being coupled to the housing, the housing being supported on the trailer.

18. A potable water extracting and dispensing apparatus comprising:
a housing having a channel extending therethrough and having an inlet end and an outlet end;
a cooling assembly being mounted in the housing and having a cooling member positioned in the channel, the cooling assembly being configured for cooling the cooling member to cause a moisture from an air to form condensate on the cooling member, the cooling assembly being a vapor-compression refrigeration assembly wherein the cooling member is an evaporator, the vapor-compression refrigeration assembly further comprising a compressor, a condenser, an expansion valve, and a refrigerant, the vapor-compression refrigeration assembly being arranged such that the compressor is operable to urge the refrigerant consecutively and cyclically through each of the condenser, the expansion valve, and the evaporator, the condenser being positioned in the channel and between the evaporator and the outlet end along a flow path extending through the channel from the inlet end of the channel to the outlet end of the channel;
a blower being mounted in the housing and positioned in the channel, the blower being configured for drawing the air into the channel through the inlet end and urging the air out of the channel through the outlet end;
a reservoir being mounted in the housing, the reservoir having an opening extending into the reservoir and being in fluid communication with the channel, the opening being positioned in relation to the evaporator such that the opening is configured for receiving the condensate from the evaporator;
a filter being in fluid communication with the reservoir, the filter being configured to filter foreign matter from the condensate;
a dispensing tube being in fluid communication with the filter and extending out of the housing to an open end of the dispensing tube;
a valve being coupled to the dispensing tube and being movable between open and closed positions, the valve being configured to permit condensate through the dispensing tube only when the valve is open;
a control circuit being operatively coupled to the cooling assembly and the blower;
a power supply being electrically coupled to the control circuit, the power supply comprising a battery;
at least one solar panel being mounted on an exterior of the housing and being electrically coupled to the battery, the at least one solar panel including a pair of solar panels, each solar panel of the pair of solar panels being mounted to an associated one of a pair of lateral sides of the housing, each solar panel of the pair of solar panels being pivotably coupled to an upper edge of the associated lateral side, each solar panel of the pair of solar panels being pivotable between a lowered position and a raised position, each solar panel of the pair of solar panels facing away from the associated lateral side when positioned in the lowered position and facing upwardly when positioned in the raised position;
an input being in communication with the control circuit for controlling the control circuit, the input being mounted on the exterior of the housing;
a power outlet being electrically coupled to the power supply and being positioned on the exterior of the housing;
a power inlet being electrically coupled to the power supply and being positioned on the exterior of the housing;
a pump being mounted in the housing and being in fluid communication with the reservoir, the pump being arranged such that the pump is configured for urging water toward the reservoir from outside of the housing;
an intake pipe being coupled to the pump and extending outwardly of the housing;
a ladder being coupled to the exterior of the housing for facilitating access to a top of the housing; and
a trailer being coupled to the housing, the housing being supported on the trailer.
